(19) United States
(12) Patent Application Publication
(10) Pub. No.: US 2025/0348943 A1
(43) Pub. Date: Nov. 13, 2025

(54) Universal Decentralized Banking, Wallet, and Vault System

(71) Applicant: FURONG BEI, SAN GABRIEL, CA (US)

(72) Inventor: FURONG BEI, SAN GABRIEL, CA (US)

(21) Appl. No.: 19/074,326

(22) Filed: Mar. 8, 2025

(51) Int. Cl. G06Q 40/06; G06Q 40/02; G06Q 40/04; H04L 9/32

(52) U.S. Cl. CPC G06Q 40/0631; G06Q 40/023; G06Q 40/024; G06Q 40/055; H04L 9/3218; G06Q 2220/00; H04L 2209/56

(57) ABSTRACT

A Universal Decentralized Banking, Wallet, Vault and BEISIGN Secure Clearing System is disclosed, integrating AI Governance, Asset Tokenization, and an Integrated Domain Ecosystem. This system establishes a robust blockchain-based financial architecture for individuals, institutions, and governments, ensuring infinite scalability, dynamic growth, and enhanced security. A Master AI Protocol autonomously manages financial operations, including risk assessment, dynamic asset valuation, anomaly detection, and governance proposals. The system supports comprehensive asset tokenization into NFTs for diverse real-world and digital assets, enabling fragmentation and use as collateral. Crucially, a novel BEISIGN Secure Clearing System replaces traditional SWIFT/switch codes by providing a privacy-preserving dual confirmation layer for transactions, enhancing security, privacy, and efficiency in clearing and settlement. An Integrated Domain Ecosystem binds curated domain names (e.g., BEISIGN.com, ATMS.com) to core smart contracts, digital identities, and tokenized assets, serving as trusted operational entry points and enhancing brand protection. This invention delivers a highly secure, private, scalable, and autonomous banking solution with significant cost reduction and enhanced trust.

### TECHNICAL FIELD

This invention relates to decentralized finance (DeFi), cross-chain financial systems, sovereign identity, AI-driven asset management, and secure clearing protocols that replace traditional switch codes. It integrates an ecosystem of domain gateways (including BEISIGN.com, ATMS.com, 168bank.com, beisx.com, beigx.com, beisec.com, beiescrow.com, beititle.com) as operational entry points for a universal banking platform, delivering secure clearing, authentication, and settlement.

### BACKGROUND

Traditional banking systems face significant limitations in scalability, privacy, and flexibility. Centralized control, slow transaction speeds, and limited growth potential restrict their ability to meet the evolving needs of a global digital economy. Centralized clearing and switching networks are inherently expensive, slow, and vulnerable to single points of failure. Modern banking urgently needs a domain-integrated decentralized clearing layer that fundamentally improves security, enhances privacy, accelerates cross-border settlement, and empowers user-controlled identity.

This invention addresses these challenges by introducing a decentralized financial architecture that combines AI-driven decision-making with blockchain technology, ensuring infinite scalability, dynamic growth, and enhanced security. Crucially, it introduces BEISIGN SIGN technology as a core component, which replaces legacy SWIFT/switch codes by providing privacy-preserving dual confirmation before transaction execution. This innovative approach ensures enhanced security, privacy, and efficiency for all clearing and settlement processes, tightly integrating with a managed domain ecosystem to provide reliable and brand-protected operational entry points.

This invention introduces:
AI governance and dynamic risk models
Cross-chain and domain-based secure clearing
Zero-knowledge proof security
NFT-based asset tokenization and management
Domain-linked, user-centric, real-world entry points via a curated domain ecosystem (e.g., BEISIGN.com, ATMS.com, 168bank.com, beisx.com, beigx.com, beisec.com, beiescrow.com, beititle.com).

### SUMMARY OF THE INVENTION

The invention delivers a Universal Decentralized Banking, Wallet, Vault and BEISIGN Secure Clearing System with AI Governance, Asset Tokenization, and Integrated Domain Ecosystem. This system is designed to:
1. Core Banking Protocols with Cross-Chain Architecture and Multi-Domain User Gateways: Establish a robust decentralized banking foundation, facilitating seamless asset management across diverse blockchain networks. It integrates a set of dedicated domain names (e.g., BEISIGN.com, ATMS.com, 168bank.com) that serve as secure and recognizable entry points and operational identifiers for users and institutions, significantly enhancing brand protection and user trust.
2. AI-Driven Secure Clearing: Implement a novel clearing mechanism that utilizes AI for optimization and integrates BEISIGN SIGN technology to provide a secondary, privacy-preserving confirmation layer for all transactions, effectively replacing traditional SWIFT/switch codes. This dual confirmation system enhances security and reduces reliance on centralized intermediaries.
3. Comprehensive Asset Tokenization and Management: Enables the conversion of a wide range of real-world and digital assets into Non-Fungible Tokens (NFT's) and their subsequent management, including fragmentation, dynamic valuation, and use as collateral within the decentralized lending framework.
4. AI Governance and Dynamic Risk Models: Employ advanced AI protocols to autonomously manage interest rates, optimize profit distribution, assess and mitigate risks, detect anomalies, and facilitate system upgrades, ensuring a self-sustaining and adaptive financial ecosystem.
5. Zero-Knowledge Security and Privacy: Leverage zero-knowledge proofs (ZKPs) and AI-managed encryption to ensure user privacy and transaction confidentiality, particularly for identity verification (KYC/AML) and sensitive data operations.
6. Universal Digital Identity Management: Provide sovereign identity management solutions with AI-based access control and recovery mechanisms, allowing users full control over their digital identities across various platforms and applications.
7. Decentralized Insurance Pools: Establish AI-managed insurance pools that provide automated claim processing and risk mitigation for various financial operations within the system.

This system provides a highly secure, private, scalable, and fully autonomous banking solution, making it suitable for individuals, families, institutions, and even nations, while significantly reducing operational costs and enhancing trust through its integrated domain ecosystem and BEISIGN secure clearing.

### BRIEF DESCRIPTION OF DRAWINGS

FIG. 1: Depicts the overall system architecture, including core protocols, smart contract modules, interoperability layers, and the integration points for AI and the domain ecosystem.

FIG. 2: Illustrates the multi-layer governance model, detailing the roles of AI in proposal generation, voting mechanisms, and compliance council oversight.

FIG. 3: Visualizes the multi-layer security approach, including AI-driven encryption, multi-signature protocols, BEISIGN confirmation flow, and real-time threat detection systems.

FIG. 4: Shows the comprehensive transaction and data flow, from initiation to final settlement across the blockchain network, highlighting the BEISIGN dual confirmation, compliance, and audit trails, and the role of domain gateways.

FIG. 5: Presents the asset tokenization and management workflow, from physical/digital asset conversion to NFT creation, fragmentation, and dynamic trading on decentralized exchanges, emphasizing domain-linked asset identifiers.

FIG. 6: Details the cross-chain interoperability mechanisms, illustrating how assets and data move securely between different blockchain networks via BEISIGN-secured bridges.

FIG. 7: Specifically outlines the Integrated Domain Ecosystem architecture, showing how registered domains (e.g., BEISIGN.com, ATMS.com) bind to core system components, smart contracts, and user identities, serving as secure entry points and brand protectors.

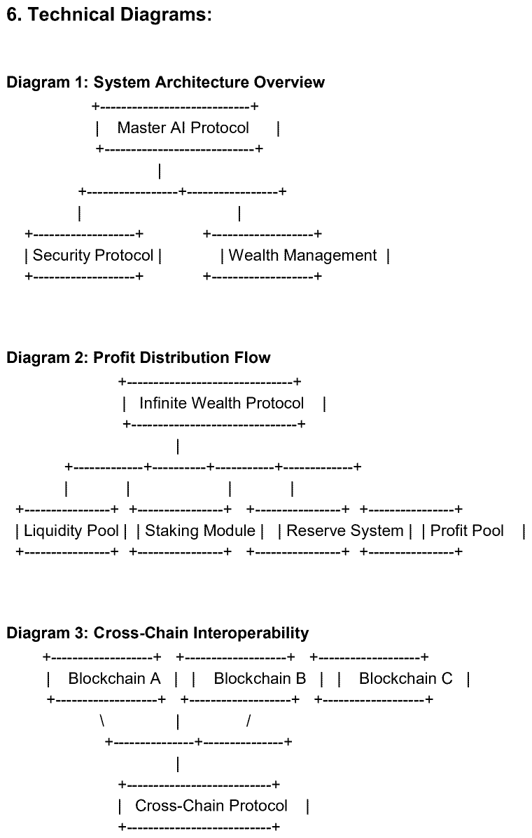

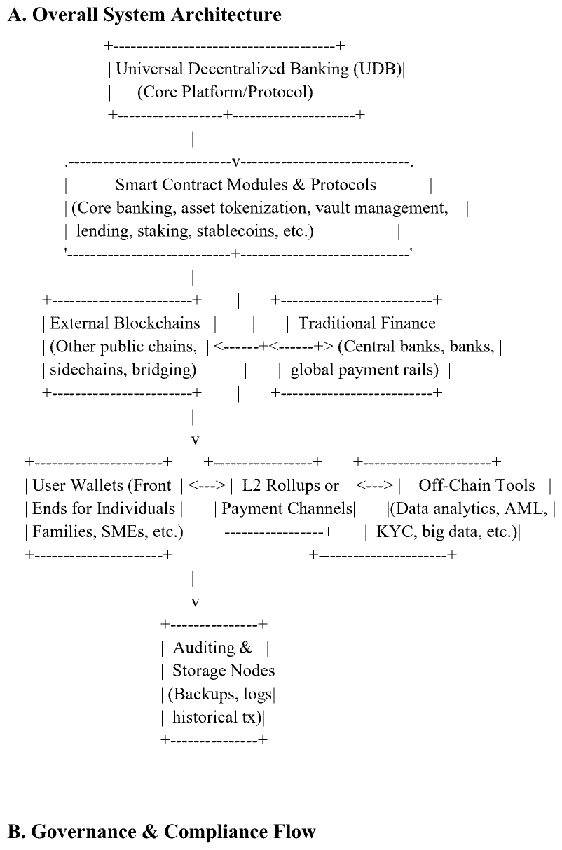

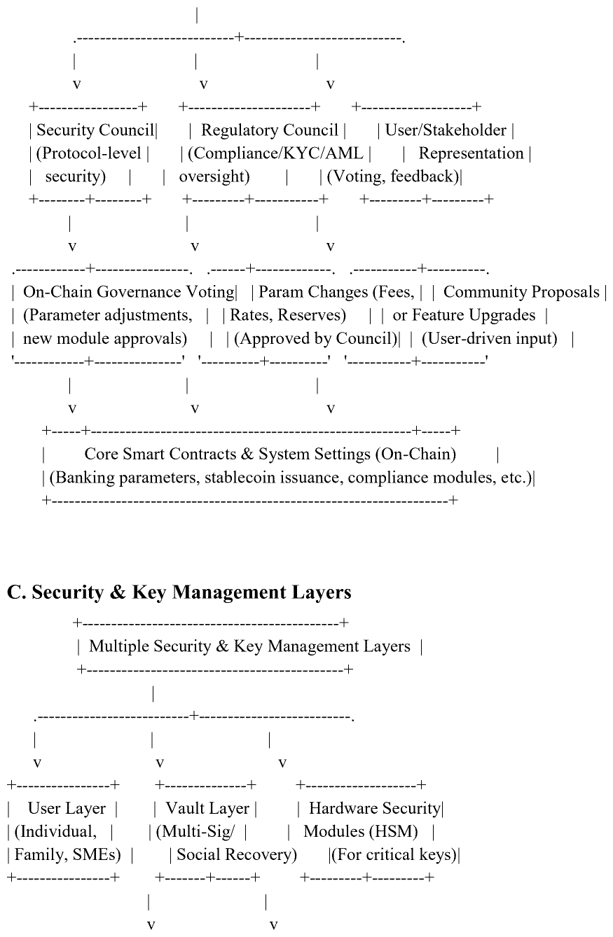

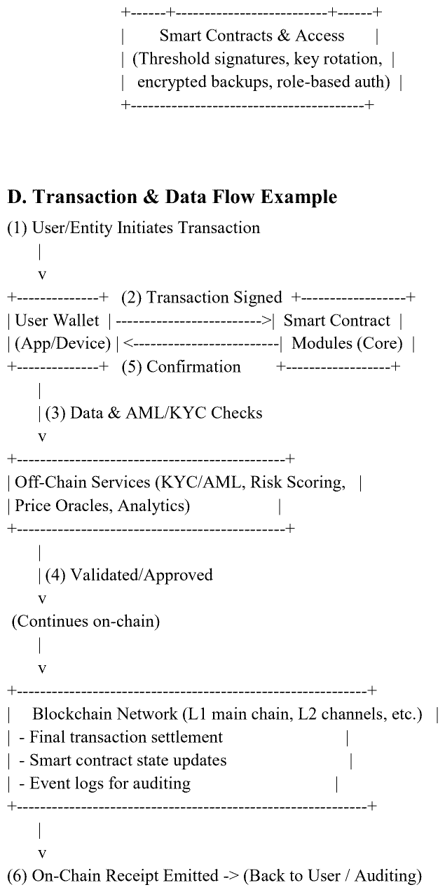

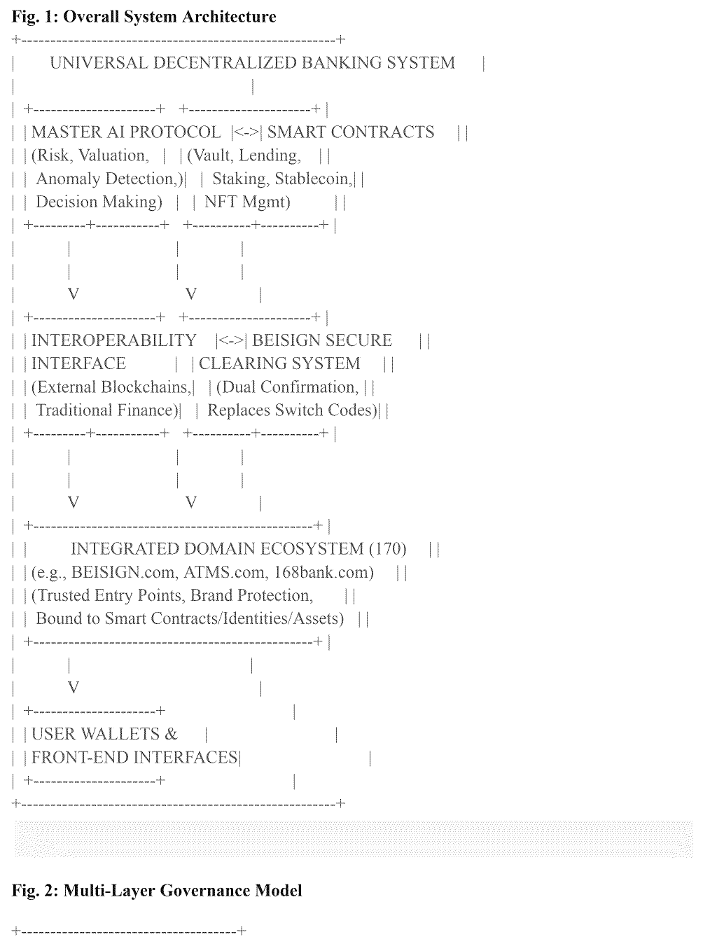

### DETAILED DESCRIPTION

The system is built upon a robust decentralized blockchain-based protocol layer (100) that functions as a secure, immutable ledger for all transactions, asset records, and system states. This layer supports:
Master AI Protocol (110): The central intelligence hub. This protocol continuously analyzes vast datasets (on-chain and off-chain) to dynamically manage interest rates, optimize profit distribution, assess risks, detect anomalies, and facilitate autonomous system upgrades. It employs various machine learning models, including deep learning for pattern recognition (e.g., fraud detection), reinforcement learning for optimal decision-making (e.g., dynamic interest rate adjustments), and predictive analytics for market forecasting.
Smart Contract Modules (120): A suite of audited smart contracts deployed on the blockchain, governing all core banking functionalities. These include:
   Vault Management (121): Secure storage for digital assets.
   Lending Protocol (122): Manages decentralized loans, collateralization, and liquidations.
   Staking Module (123): Facilitates staking for network security and rewards distribution.
   Stablecoin Functionality (124): Manages the issuance and redemption of stablecoins pegged to fiat currencies or other assets.
   Asset Tokenization and NFT Management (125): Handles the conversion of real-world and digital assets into NFTs, their fragmentation, and lifecycle management.
Interoperability Interface (130): Enables seamless and secure communication and asset transfer with external blockchains (131) and traditional financial systems (132). This interface utilizes various bridging technologies and API integrations.
User Wallets & Front-end Interfaces (140): A suite of applications (web, mobile, desktop) providing users with secure access to their assets, multi-signature approvals, and social key recovery mechanisms.
Layer 2 Mechanisms (150): Integrates scaling solutions like rollups, payment channels, or sidechains to reduce on-chain transaction load and enhance throughput, ensuring infinite scalability.
Off-Chain Tools (160): Includes data analytics, AML/KYC tools (e.g., external KYC providers, identity verification services), risk scoring engines, and price oracles (161) to feed real-time external data to the Master AI Protocol.
Integrated Domain Ecosystem (170): A critical component where specific, curated domain names (e.g., BEISIGN.com, ATMS.com, 168bank.com, beisx.com, beigx.com, beisec.com, beiescrow.com, beititle.com) are intrinsically linked to core smart contracts, digital identities, and system functionalities. These domains serve as trusted, user-friendly gateways to the system, acting as brand protectors and enhancing the overall accessibility and trust in the decentralized environment. They are managed to ensure their operational integrity and become key intangible assets.

### 5. Governance Architecture (Ref. FIG. 2)

The system features a robust decentralized governance model (200) ensuring self-sustainability and community oversight:
Governance Token/Reputation-Based Voting (210): Decisions are made via a token-weighted voting mechanism, where governance token holders or participants with a proven reputation vote on proposals.
Multiple Councils/Committees (220): Specialized councils are established:
   Security Council (221): Oversees security protocols and critical updates.
   Compliance Council (222): Ensures adherence to regulatory standards (e.g., AML/KYC policies).
   User Representation (223): Advocates for the user base, ensuring user-centric development.
On-Chain Parameter Adjustment (230): Core system variables like interest rates, fees, and reserve ratios can be modified through a multi-party approval process, requiring consensus from the governance bodies.
AI-Driven Governance (240): The Master AI Protocol (110) actively participates in governance by:
   Proposing Updates: Identifying vulnerabilities, optimizing performance, and suggesting protocol upgrades.
   Evaluating Proposals: Analyzing potential impacts of community proposals on system stability and profitability.
   Dynamic Adjustment: Automatically implementing approved parameter changes (e.g., AI-based adjustment of interest rates, fees, reserves based on market conditions),

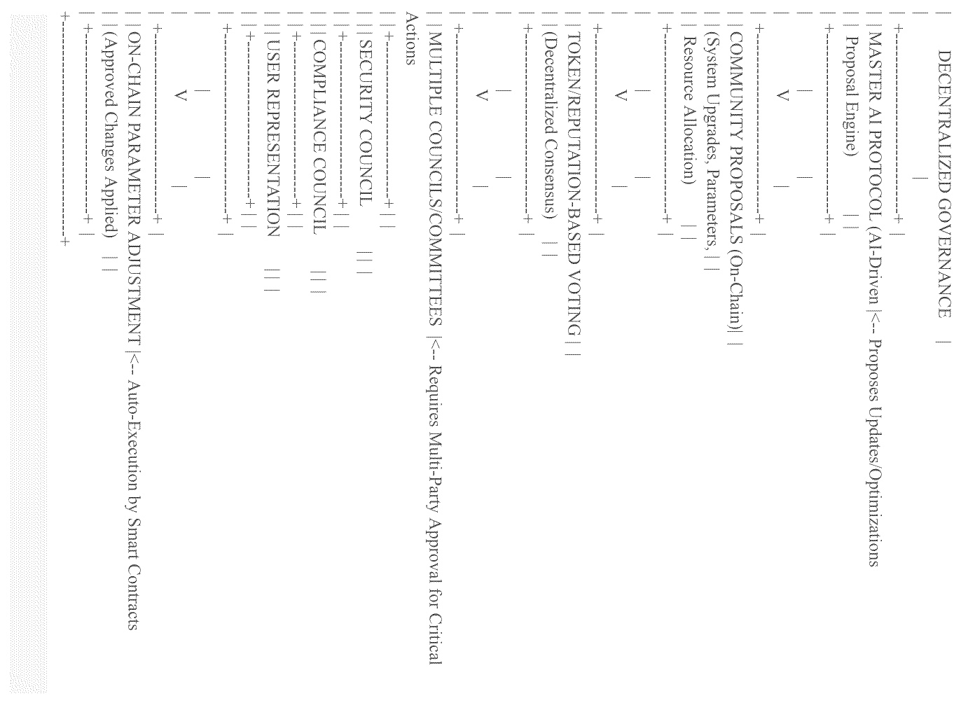

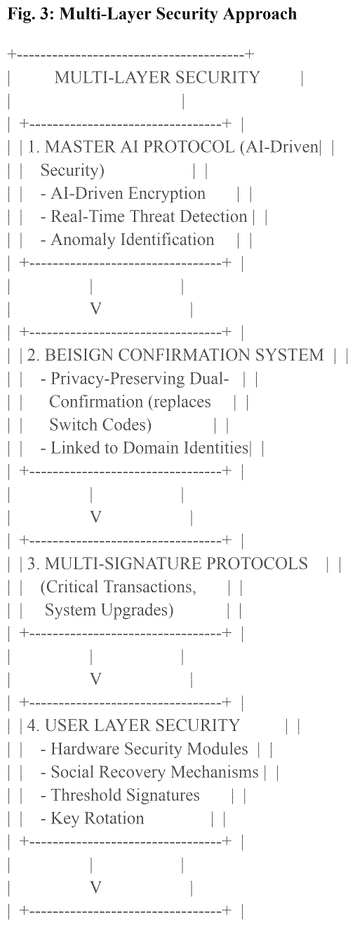

### 6. Security and Key Management Layers (Ref. FIG. 3)

The system implements a multi-layered security approach:
AI-Driven Encryption (310): Utilizes advanced, potentially quantum-resistant encryption algorithms managed by AI to protect sensitive data and critical clearing operations.
Multi-Signature Protocols (320): Critical transactions (e.g., large transfers, system upgrades) require multiple authorized parties' cryptographic signatures.
BEISIGN Confirmation (330): Introduces a novel dual-confirmation mechanism. Before any transaction (especially high-value institutional transfers) is executed, it requires a BEISIGN SIGN (a unique, privacy-preserving secondary confirmation) that replaces traditional SWIFT/switch codes. This confirmation is linked to specific domain identities and audited for integrity but keeps transaction details private until confirmed.
Threat Detection Systems (340): The Master AI Protocol (110) continuously monitors the network for unusual patterns, potential attacks, and fraudulent activities, leveraging real-time anomaly detection and predictive analytics.
User Layer Security (350): Individual users benefit from:
   Hardware Security Modules (HSM) (351): For securing critical keys.
   Social Recovery (352): Mechanisms for secure key recovery with guardian assistance.
   Threshold Signatures (353): Distributing key control among multiple parties.
   Key Rotation & Encrypted Backups (354): Regular key updates and secure encrypted backups,
Domain-Linked Security (360): The integrated domain ecosystem (170) provides an additional layer of security by linking trusted domains to verified smart contracts and user identities, preventing phishing and ensuring users interact with authentic system components.

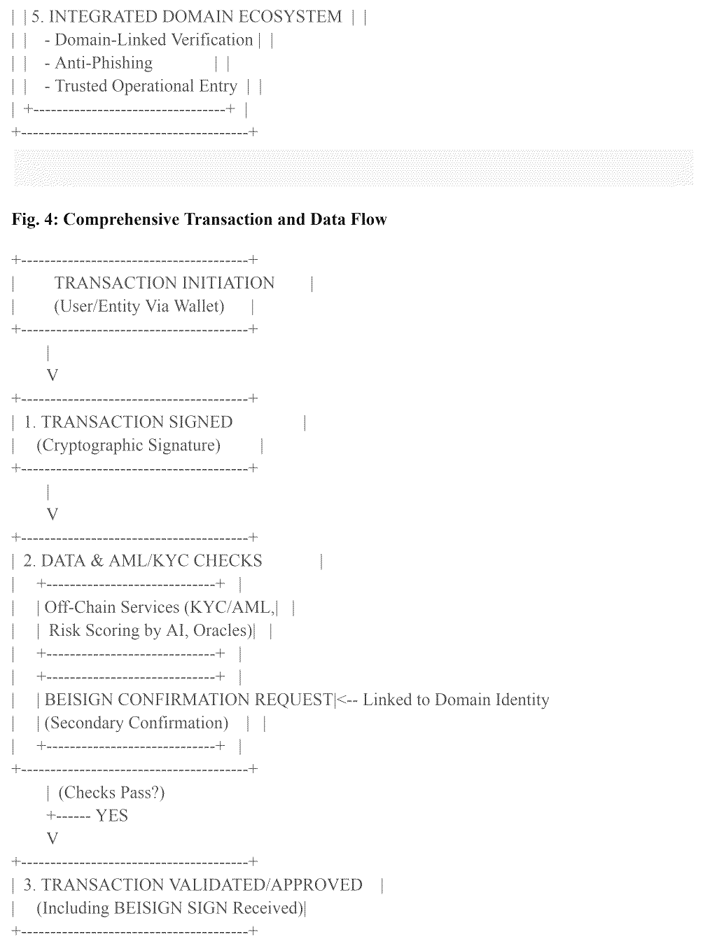

### 7. Transaction and Data Flow Example (Ref. FIG. 4)

A typical transaction flow within the system:
1. User/Entity Initiates Transaction (410): A user or institution initiates a transaction via their wallet interface.
2. Transaction Signed (420): The transaction is cryptographically signed by the user's wallet.
3. Data & AML/KYC Checks (430): Before execution, the transaction undergoes automated checks:
   Off-Chain Services (431): External KYC/AML verification (leveraging ZKPs for privacy), risk scoring by the AI, and price oracle feeds are consulted.
   BEISIGN Confirmation Request (432): A request is sent for the secondary BEISIGN SIGN confirmation, linked to domain identity reputation.
4. Validated/Approved (440): Once all checks are passed, and the BEISIGN confirmation is received, the transaction is validated.
5. Smart Contract Execution (450): The core Smart Contract Modules (120) execute the transaction on the blockchain.
6. Confirmation (460): The transaction is confirmed on-chain, and an auditable but private BEISIGN confirmation record replaces traditional SWIFT/switch codes for institutional transfers.

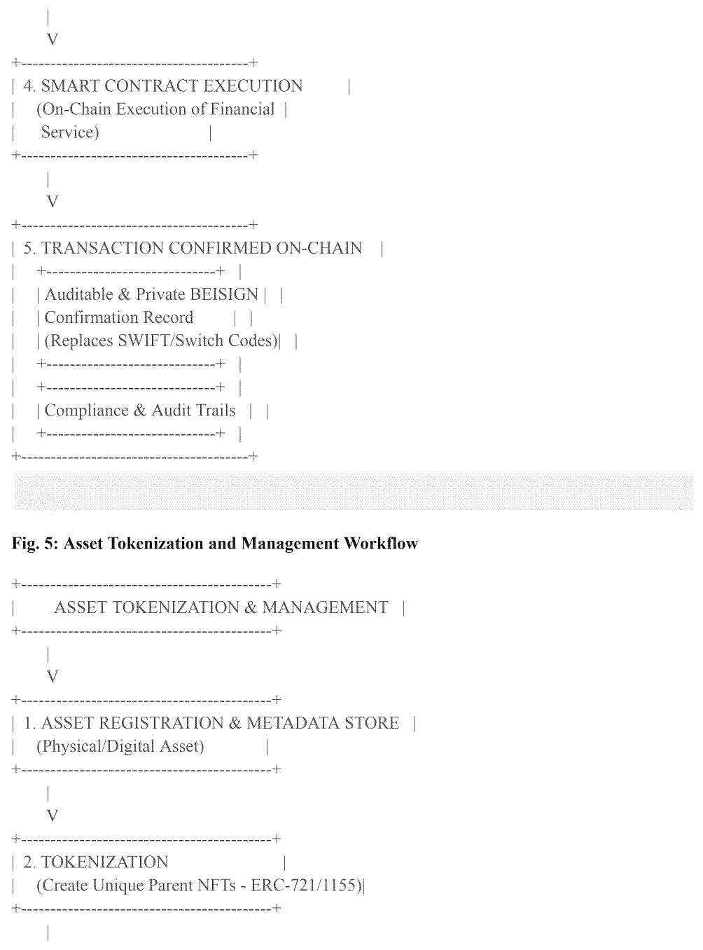

### 8. Asset Tokenization and Management (Ref. FIG. 5)

The system enables comprehensive asset tokenization:
Asset Registry (510): Physical or digital assets are registered, and their metadata securely stored.
Tokenization (520): Assets are converted into unique NFTs (ERC-721/ERC-1155), ensuring verifiable ownership and authenticity.
Fragmenter (530): Parent NFTs can be fragmented into smaller, more liquid NFT fragments (e.g., ERC-20 tokens representing shares of the NFT).
NFT Fragments (540): These fragments are then tradable.
Dynamic Trading Protocol (550): A pricing mechanism, powered by the Master AI Protocol (110), enables dynamic trading of fragmented NFTs on decentralized exchanges, optimizing liquidity pools and yield.
Cross-Chain Bridge (560): Facilitates the secure movement of NFT fragments across different blockchain networks, managed by BEISIGN-secured inter-chain protocols,
Domain-Linked Asset Identifiers (570): NFTs and their fragments can be associated with specific domains (e.g., realestate.beititle.com for a tokenized property) to enhance recognition, authenticity, and transferability.

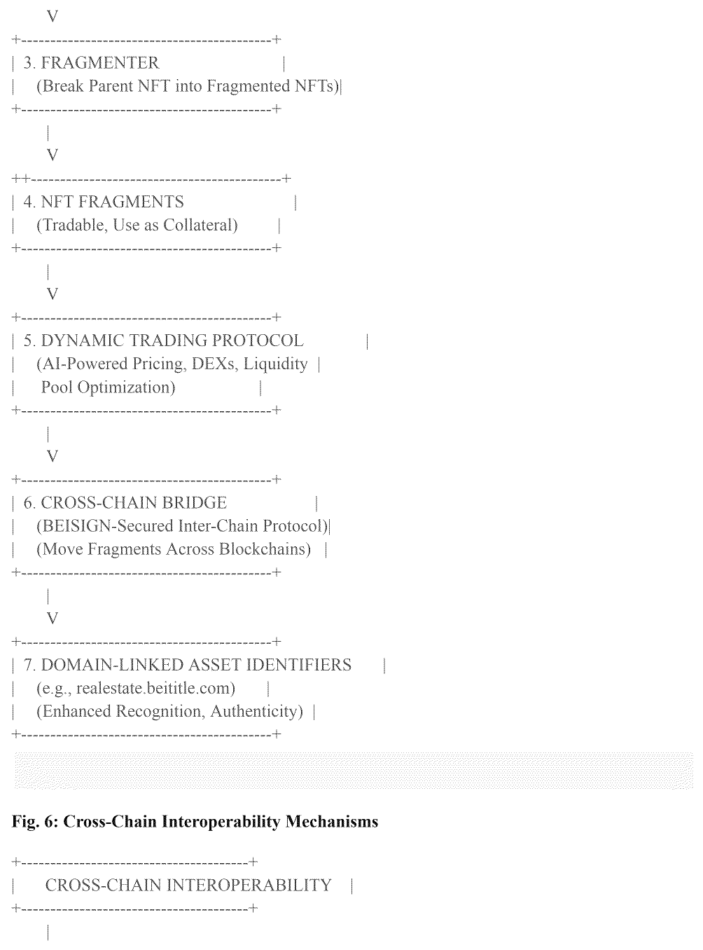

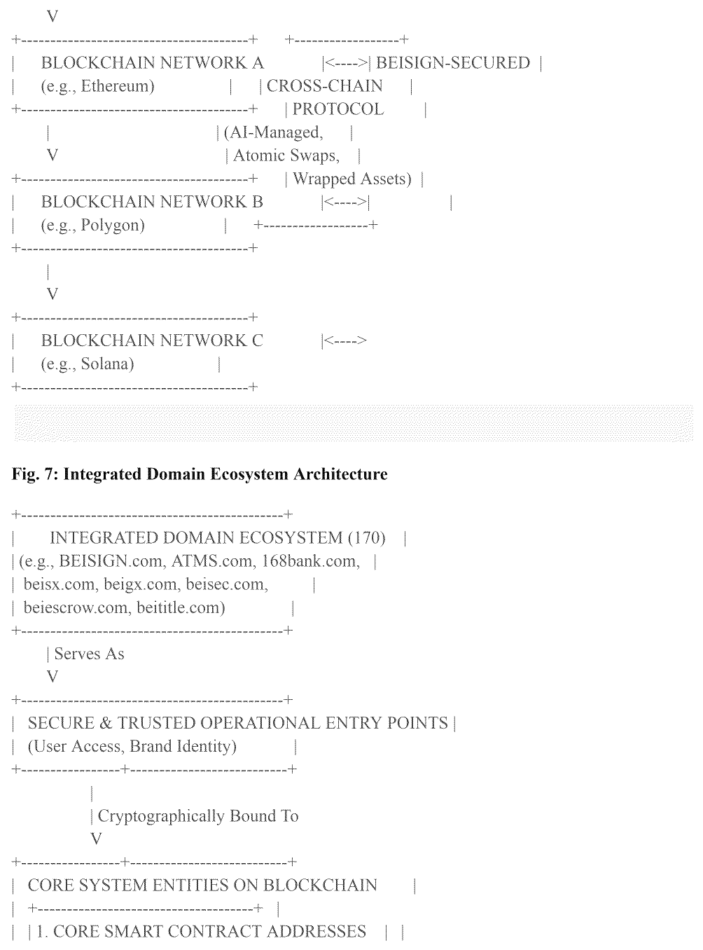

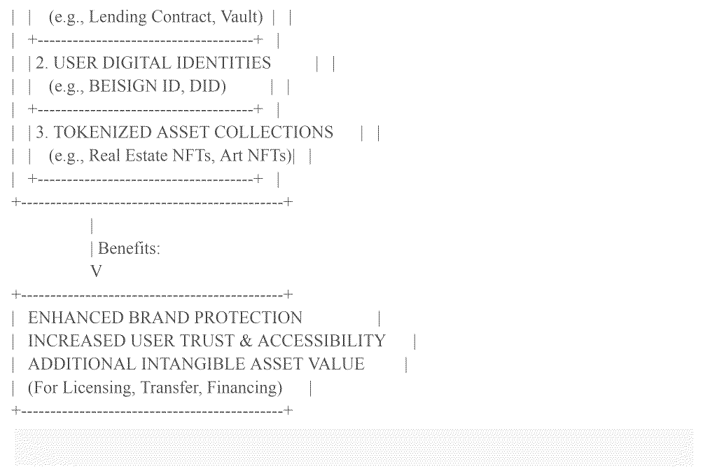

### 9. Cross-Chain Interoperability (Ref. FIG. 6)

The system implements robust cross-chain capabilities:
Blockchain Interconnection (610): Connects various blockchain networks (Blockchain A, B, C).
Cross-Chain Protocol (620): A secure protocol, enhanced by BEISIGN technology, facilitates asset and data exchange across these networks. It uses AI to manage cross-chain interoperability and synchronization, ensuring data consistency and security across all connected chains.
Atomic Swaps and Wrapped Assets (630): Mechanisms like atomic swaps and wrapped tokens ensure secure, trustless transfer of assets between different blockchains.

### 10. AI-Based Regulatory Compliance (Ref. FIG. 2, Part of 250 in Previous Descriptions)

Continuous Monitoring: The Master AI Protocol (110) continuously monitors all transactions for compliance with AML/KYC regulations and other jurisdictional requirements.
Report Generation: Uses AI to automatically generate compliance reports and audit trails for regulators, storing them on-chain for immutability.
Digital ID Verification (BEISIGN ID): Verifies identities using AI-analyzed biometric data and zero-knowledge proofs, supporting cross-border digital ID management with selective disclosure. This BEISIGN ID is inherently linked to the domain ecosystem.

### 11. Advanced Financial Mechanics

Decentralized Insurance Pool: An AI-managed insurance pool funded by staking and premium contributions. It supports automated claim processing using smart contracts, providing a safety net for system participants.
Gravitational Profit Pool: An AI-managed profit pool that dynamically redistributes surplus profits to users based on their contributions, staking levels, and governance participation, ensuring sustainable growth by reinvesting a portion of profits.
Perpetual Yield Optimization: Uses AI to analyze yield opportunities across various DeFi platforms, dynamically reallocating assets to maximize yields while managing risk autonomously,

### 12. Universal Digital Identity Management

Supports sovereign identity management with AI-based access control and recovery mechanisms, ensuring privacy and security through AI-managed encryption protocols. This identity can be linked to the domain ecosystem (e.g., yourname.beisign.com).

### 13. Inter-Chain Hive Protocol

Facilitates asset and data exchange across multiple blockchain networks using Al to manage cross-chain interoperability and synchronization, ensuring data consistency and security across all nodes. This protocol is enhanced by BEISIGN's secure clearing capabilities.

### CLAIMS

### Independent Claims

Claim 1: Universal Decentralized Banking and Asset Management System

A universal decentralized banking system for managing assets across individuals, families, institutions, and governments, comprising:
(a) a blockchain-based protocol layer configured to immutably validate transactions, store ledger data, and host smart contracts;
(b) a Master Artificial Intelligence (AI) Protocol electronically coupled to said blockchain-based protocol layer, configured to:
   (i) continuously analyze diverse data including on-chain transaction data, smart contract states, off-chain market data obtained via decentralized oracle networks, and user behavioral data;
   (ii) autonomously perform real-time risk assessments, dynamic asset valuations, and anomaly detection based on said analyzed data; and
   (iii) generate adaptive financial decisions and system optimization parameters without continuous human intervention;
(c) one or more smart contract modules deployed on said blockchain-based protocol layer, configured to autonomously execute core banking functionalities including vault management, lending, staking, stablecoin functionality, and asset tokenization and Non-Fungible Token (NFT) management, wherein said asset tokenization and NFT management converts assets into unique NFTs and enables their fragmentation and use as collateral;
(d) an interoperability interface configured to facilitate secure and atomic asset and data exchange with external blockchains and traditional financial systems;
(e) a BEISIGN Secure Clearing System integrated within said interoperability interface and smart contract modules, configured to:
   (i) provide a privacy-preserving secondary confirmation for financial transactions, replacing traditional switch codes;
   (ii) ensure secure, dual-confirmation clearing and settlement across blockchain networks; and
   (iii) link said secondary confirmation to registered domain identities; and
(f) an Integrated Domain Ecosystem comprising a plurality of curated domain names, wherein each domain name is configured to be securely bound to at least one of: a core smart contract address within the system, a digital identity of a user or entity, or a collection of tokenized assets, thereby serving as a trusted operational entry point, enhancing brand protection, and increasing the system's commercial transfer and licensing value.

Claim 2: Method for AI-Driven Autonomous Financial and Asset Management

A computer-implemented method for autonomous financial and asset management in a decentralized banking system, comprising:
(a) continuously collecting and processing, by a Master AI Protocol, diverse data including on-chain transaction data, off-chain market data from decentralized oracle networks, and user behavioral data;
(b) performing, by said Master AI Protocol, real-time risk assessments, dynamic asset valuations, and anomaly detection based on said processed data;
(c) autonomously executing, by one or more smart contracts hosted on a blockchain-based protocol layer, financial services without continuous human intervention, said financial services including:
   (i) managing vault operations, lending, and staking;
   (ii) tokenizing assets into Non-Fungible Tokens (NFTs) and managing their fragmentation and use as collateral;
   (iii) processing automated loan issuance, interest adjustments, repayments, and settlements based on decisions from said Master AI Protocol;
(d) ensuring secure transaction clearing by a BEISIGN Secure Clearing System, said ensuring comprising;
   (i) providing a privacy-preserving secondary confirmation for financial transactions, replacing traditional switch codes; and
   (ii) linking said secondary confirmation to registered domain identities;
(e) executing, by said smart contracts, automated compliance and regulatory checks, including decentralized identity verification utilizing zero-knowledge proofs; and
(f) leveraging an Integrated Domain Ecosystem by binding at least one curated domain name to a core smart contract address, a digital identity, or a collection of tokenized assets within the system, to enhance user trust, brand protection, and operational accessibility.

Claim 3: Dynamic Governance, Security, and Cross-Chain Framework with Domain Integration

A dynamic governance, security, and cross-chain framework for an autonomous decentralized banking system, comprising:
(a) a decentralized governance model including:
   (i) a governance token or reputation-based voting mechanism for decentralized decision-making;
   (ii) multi-signature protocols requiring multi-party approval for critical system updates and high-value transactions; and
   (iii) an AI-driven proposal engine configured to autonomously identify system vulnerabilities, recommend protocol upgrades based on performance analysis, and propose asset valuation updates;
(b) a multi-layered security architecture including:
   (i) AI-driven encryption and real-time threat detection systems;
   (ii) BEISIGN Confirmation technology configured to provide a privacy-preserving dual-confirmation for transactions, replacing traditional switch codes; and
   (iii) AI-based digital identity verification utilizing biometric data and zero-knowledge proofs;
(c) cross-chain interoperability modules configured to facilitate secure atomic asset and data exchange across multiple heterogeneous blockchain networks; and
(d) an Integrated Domain Ecosystem comprising a plurality of curated domain names (e.g., BEISIGN.com, ATMS.com, 168bank.com), wherein each domain name is configured to:
   (i) serve as a secure and trusted operational entry point for the system;
   (ii) be cryptographically bound to core smart contract addresses, user digital identities, and tokenized assets within the system to ensure brand integrity and prevent phishing; and
   (iii) enhance the system's intangible asset valuation for commercial licensing, transfer, and financing.

4. The system of claim 1, wherein the Master AI Protocol employs deep learning neural networks and reinforcement learning algorithms, trained on historical and real-time data, for dynamic risk assessment, predictive analytics, and autonomous loan decision-making,

5. The system of claim 1, wherein the smart contract modules dynamically adjust interest rates, loan terms, and collateral requirements based on real-time risk assessments and market conditions determined by the Master AI Protocol.

6. The system of claim 1, wherein the asset tokenization and NFT management includes converting at least one of real estate, intellectual property, financial securities, or digital art into unique NFTs and their fragments.

7. The system of claim 1, wherein the Integrated Domain Ecosystem includes decentralized naming services (e.g., ENS, or custom blockchain-based DNS) to manage the binding of domains to on-chain entities.

8. The system of claim 1, wherein the BEISIGN Secure Clearing System's dual confirmation is auditable for regulatory compliance while preserving transaction privacy through cryptographic techniques.

9. The system of claim 1, wherein the Master AI Protocol includes an anomaly detection system that continuously monitors financial and asset-related transactions to identify and prevent fraud patterns, automatically triggering predefined security responses.

10. The system of claim 1, wherein the governance module's AI-driven proposal engine autonomously converts identified vulnerabilities and recommended upgrades into formal proposals for community vote.

11. The method of claim 2, wherein the Master Al Protocol dynamically optimizes asset-backed repayment schedules based on real-time user activity, market fluctuations, and predictive financial models.

12. The method of claim 2, further comprising generating immutable audit reports of all financial and asset management operations, which are stored on the blockchain-based protocol layer for regulatory auditability and transparency.

13. The method of claim 2, wherein the BEISIGN Secure Clearing System leverages domain identity reputation to enhance the trustworthiness of transaction confirmations and user authentication.

14. The framework of claim 3, wherein the AI-driven encryption includes quantum-resistant cryptographic algorithms to protect critical clearing and vault operations.

15. The framework of claim 3, wherein the cross-chain interoperability modules execute atomic settlements to eliminate counterparty risk in multi-chain transactions.

16. The system of claim 1, wherein AI algorithms periodically simulate stress scenarios on asset-backed portfolios (e.g., market crashes, liquidity crises) and recommend real-time adjustments to lending parameters or liquidity allocation to maintain system stability.

17. The system of claim 1, wherein an Al-managed decentralized insurance pool is funded by staking and premium contributions, supporting automated claim processing via smart contracts.

18. The system of claim 1, wherein the asset tokenization and NFT management module facilitates the dynamic trading of fragmented NFTs on decentralized exchanges, with prices dynamically determined by the Master AI Protocol's pricing algorithms.

19. The system of claim 1, wherein a Natural Language Processing (NLP) interface enables users to interact with core system functions and query asset information using conversational commands.

20. The system of claim 1, wherein AI-driven liquidity optimizers dynamically allocate capital reserves across various asset classes and cross-chain bridges based on real-time gas fees, network congestion, and yield opportunities, ensuring optimal liquidity and minimizing slippage.

1. Universal Decentralized Banking and Asset Management System
A universal decentralized banking system for managing assets across individuals, families, institutions, and governments, comprising:
(a) a blockchain-based protocol layer configured to immutably validate transactions, store ledger data, and host smart contracts;
(b) a Master Artificial Intelligence (AI) Protocol electronically coupled to said blockchain-based protocol layer, configured to:
(i) continuously analyze diverse data including on-chain transaction data, smart contract states, off-chain market data obtained via decentralized oracle networks, and user behavioral data;
(ii) autonomously perform real-time risk assessments, dynamic asset valuations, and anomaly detection based on said analyzed data; and
(iii) generate adaptive financial decisions and system optimization parameters without continuous human intervention;
(c) one or more smart contract modules deployed on said blockchain-based protocol layer, configured to autonomously execute core banking functionalities including vault management, lending, staking, stablecoin functionality, and asset tokenization and Non-Fungible Token (NFT) management, wherein said asset tokenization and NFT management converts assets into unique NFTs and enables their fragmentation and use as collateral;
(d) an interoperability interface configured to facilitate secure and atomic asset and data exchange with external blockchains and traditional financial systems;
(e) a BEISIGN Secure Clearing System integrated within said interoperability interface and smart contract modules, configured to:
(i) provide a privacy-preserving secondary confirmation for financial transactions, replacing traditional switch codes;
(ii) ensure secure, dual-confirmation clearing and settlement across blockchain networks; and
(iii) link said secondary confirmation to registered domain identities; and
(f) an Integrated Domain Ecosystem comprising a plurality of curated domain names, wherein each domain name is configured to be securely bound to at least one of: a core smart contract address within the system, a digital identity of a user or entity, or a collection of tokenized assets, thereby serving as a trusted operational entry point, enhancing brand protection, and increasing the system's commercial transfer and licensing value.

2. Method for AI-Driven Autonomous Financial and Asset Management
A computer-implemented method for autonomous financial and asset management in a decentralized banking system, comprising:
(a) continuously collecting and processing, by a Master AI Protocol, diverse data including on-chain transaction data, off-chain market data from decentralized oracle networks, and user behavioral data;
(b) performing, by said Master AI Protocol, real-time risk assessments, dynamic asset valuations, and anomaly detection based on said processed data;
(c) autonomously executing, by one or more smart contracts hosted on a blockchain-based protocol layer, financial services without continuous human intervention, said financial services including:
(i) managing vault operations, lending, and staking;
(ii) tokenizing assets into Non-Fungible Tokens (NFTs) and managing their fragmentation and use as collateral;
(iii) processing automated loan issuance, interest adjustments, repayments, and settlements based on decisions from said Master AI Protocol;
(d) ensuring secure transaction clearing by a BEISIGN Secure Clearing System, said ensuring comprising:
(i) providing a privacy-preserving secondary confirmation for financial transactions, replacing traditional switch codes; and
(ii) linking said secondary confirmation to registered domain identities;
(e) executing, by said smart contracts, automated compliance and regulatory checks, including decentralized identity verification utilizing zero-knowledge proofs; and
(f) leveraging an Integrated Domain Ecosystem by binding at least one curated domain name to a core smart contract address, a digital identity, or a collection of tokenized assets within the system, to enhance user trust, brand protection, and operational accessibility.

3. Dynamic Governance, Security, and Cross-Chain Framework with Domain Integration
A dynamic governance, security, and cross-chain framework for an autonomous decentralized banking system, comprising:
(a) a decentralized governance model including:
(i) a governance token or reputation-based voting mechanism for decentralized decision-making;
(ii) multi-signature protocols requiring multi-party approval for critical system updates and high-value transactions; and
(iii) an AI-driven proposal engine configured to autonomously identify system vulnerabilities, recommend protocol upgrades based on performance analysis, and propose asset valuation updates;
(b) a multi-layered security architecture including:
(i) AI-driven encryption and real-time threat detection systems;
(ii) BEISIGN Confirmation technology configured to provide a privacy-preserving dual-confirmation for transactions, replacing traditional switch codes; and
(iii) AI-based digital identity verification utilizing biometric data and zero-knowledge proofs;
(c) cross-chain interoperability modules configured to facilitate secure atomic asset and data exchange across multiple heterogeneous blockchain networks; and
(d) an Integrated Domain Ecosystem comprising a plurality of curated domain names (e.g., BEISIGN.com, ATMS.com, 168bank.com), wherein each domain name is configured to:
(i) serve as a secure and trusted operational entry point for the system;
(ii) be cryptographically bound to core smart contract addresses, user digital identities, and tokenized assets within the system to ensure brand integrity and prevent phishing; and
(iii) enhance the system's intangible asset valuation for commercial licensing, transfer, and financing.

4. The system of claim 1, wherein the Master AI Protocol employs deep learning neural networks and reinforcement learning algorithms, trained on historical and real-time data, for dynamic risk assessment, predictive analytics, and autonomous loan decision-making.

5. The system of claim 1, wherein the smart contract modules dynamically adjust interest rates, loan terms, and collateral requirements based on real-time risk assessments and market conditions determined by the Master AI Protocol,

6. The system of claim 1, wherein the asset tokenization and NFT management includes converting at least one of real estate, intellectual property, financial securities, or digital art into unique NFTs and their fragments.

7. The system of claim 1, wherein the Integrated Domain Ecosystem includes decentralized naming services (e.g., ENS, or custom blockchain-based DNS) to manage the binding of domains to on-chain entities.

8. The system of claim 1, wherein the BEISIGN Secure Clearing System's dual confirmation is auditable for regulatory compliance while preserving transaction privacy through cryptographic techniques.

9. The system of claim 1, wherein the Master AI Protocol includes an anomaly detection system that continuously monitors financial and asset-related transactions to identify and prevent fraud patterns, automatically triggering predefined security responses.

10. The system of claim 1, wherein the governance module's AI-driven proposal engine autonomously converts identified vulnerabilities and recommended upgrades into formal proposals for community vote.

11. The method of claim 2, wherein the Master AI Protocol dynamically optimizes asset-backed repayment schedules based on real-time user activity, market fluctuations, and predictive financial models.

12. The method of claim 2, further comprising generating immutable audit reports of all financial and asset management operations, which are stored on the blockchain-based protocol layer for regulatory auditability and transparency.

13. The method of claim 2, wherein the BEISIGN Secure Clearing System leverages domain identity reputation to enhance the trustworthiness of transaction confirmations and user authentication.

14. The framework of claim 3, wherein the AI-driven encryption includes quantum-resistant cryptographic algorithms to protect critical clearing and vault operations.

15. The framework of claim 3, wherein the cross-chain interoperability modules execute atomic settlements to eliminate counterparty risk in multi-chain transactions.

16. The system of claim 1, wherein AI algorithms periodically simulate stress scenarios on asset-backed portfolios (e.g., market crashes, liquidity crises) and recommend real-time adjustments to lending parameters or liquidity allocation to maintain system stability.

17. The system of claim 1, wherein an AI-managed decentralized insurance pool is funded by staking and premium contributions, supporting automated claim processing via smart contracts.

18. The system of claim 1, wherein the asset tokenization and NFT management module facilitates the dynamic trading of fragmented NFTs on decentralized exchanges, with prices dynamically determined by the Master AI Protocol's pricing algorithms.

19. The system of claim 1, wherein a Natural Language Processing (NLP) interface enables users to interact with core system functions and query asset information using conversational commands.

20. The system of claim 1, wherein AI-driven liquidity optimizers dynamically allocate capital reserves across various asset classes and cross-chain bridges based on real-time gas fees, network congestion, and yield opportunities, ensuring optimal liquidity and minimizing slippage.
